(19) United States
(12) Patent Application Publication
(10) Pub. No.: US 2015/0286781 A1
(43) Pub. Date: Oct. 8, 2015

(54) PACEMAKER ICD ELECTRONIC HEALTH RECORD

(71) Applicant: Maxwell Opoku Agyemang, Miami, FL (US)

(72) Inventor: Maxwell Opoku Agyemang, Miami, FL (US)

(73) Assignee: PHYSICIANS CREEK INC., South Miami, FL (US)

(21) Appl. No.: 14/244,002

(22) Filed: Apr. 3, 2014

(51) Int. Cl. G06F 19/00

(52) U.S. Cl. CPC G06F 19/322

(57) ABSTRACT

This invention concerns a novel practical application of using secured electronic form of medical record keeping in protecting and securing patient privacy specifically and only in regards to information pertaining to patients' pacemaker and or icd data or interrogation record.

After system and technology approval by the Office of Civil Rights, Department of Health and Human Services and Health IT., patients' consents will allow securing information regarding their pacemaker and icd interrogation.

The PACEMAKER ICD ELECTRONIC HEALTH RECORD www.pacemakeremr.com when implemented will allow secured but easy access to this specific (pacemaker icd data or interrogation data) health information as allowed by the patient, especially when they travel from one facility to another or from one provider to another. It will also prevent any possible unnecessary checking of the instrument since the information will be accessible online.

### BACKGROUND OF THE INVENTION

Paper and other physical formats of transporting, saving and storing health information are rapidly being outdated for their relatively difficult access by other qualified personnel, their vulnerability to being damaged and stolen. There are currently over five hundred certified electronic health record vendors dispersed among various health facilities and used by individual doctors and providers. In spite a common problem exist.

### THE PROBLEM

Patients have their pacemakers or implantable cardiac defibrillator (ICD) checked every 6 months or at least ones in a year. The records during this time of interrogation is mostly stored on CD's or printed out in paper formats. These methods of saving patient information poses a great risk in losing patient private health information; which fails under the bigger fervent goal of using electronic medical records to avert such occurrences. The PACEMAKER ICD ELECTRONIC HEALTH RECORD as is in the name is specifically created to securely capture data regarding these two specific classes of devices in a secured electronic format.

### THE BENEFITS

This will allow easy electronic access to the information when patients change Cardiologist. Also it will eliminate the redundant interrogation of pacermakers and ICD's since this information will be available to access online per the permission of the patient. In addition, it will create a more secured reference location for pacemaker and icd interrogation data.

### THE PROCESS

When this specific health record or portal is created, every time that a nurse or a technician interrogates a patient's pacemaker or icd, the data he/she acquires will be transmitted securely to www.pacemakeremr.com where the information will be secured in PDF or TXT format. By this time, documented consent would have already been obtained from the patient. This information can also be allowed by the patient for viewing if there is another admission in another hospital or health facility. Hospitals, qualified health professionals will have to obtain consent from the patient before saving their health record (pacemaker and icd) to this protected electronic medical record

### SUMMARY

The broad and overall intent of this invention is to develop a secured web portal for safeguarding pacemaker and icd interrogation data.

1. Patient health information comprising of:
Electronic form of health information;
Secured transmittal and storage of patient information;
Protecting only data or information regarding patient pacemakers and implantable cardiac defibrillators;
One common website for pacemaker and icd data that can be assessed using patient last name and social security as allowed by the patient;
